(19) United States
(12) Patent Application Publication
(10) Pub. No.: US 2018/0145524 A1
(43) Pub. Date: May 24, 2018

(54) BATTERY CHARGING CIRCUIT AND CHARGING METHOD THEREOF

(71) Applicant: ANPEC ELECTRONICS CORPORATION, Hsinchu City (TW)

(72) Inventor: CHIH-NING CHEN, TAIPEI CITY (TW)

(21) Appl. No.: 15/458,190

(22) Filed: Mar. 14, 2017

(30) Foreign Application Priority Data
Nov. 18, 2016 (TW) 105137872

(51) Int. Cl. H02J 7/00

(52) U.S. Cl. CPC H02J 7/0052; H02J 7/007

(57) ABSTRACT

A battery charging circuit for charging a battery is provided. The battery charging circuit includes a control module and a charging mode adjusting module. The charging mode adjusting module adjusts a charging mode according to a voltage value or a current value of the battery. The charging mode adjusting module includes a charging unit and a detecting unit. The charging unit provides a charging current or a charging voltage to charge the battery. The detecting unit is electrically connected to the charging unit to detect the voltage value or the current value of the battery.

### BACKGROUND

### 1. Technical Field

The present disclosure generally relates to a battery charging circuit and, more particularly, to a battery charging circuit with a fast charging mode.

### 2. Description of Related Art

Referring to FIG. 1, the voltage profile of a general charging circuit is shown. During the process of charging a battery, the battery is first charged in a constant-current mode, and then in a constant-voltage mode when a battery external terminal voltage V_{BATO} (the voltage difference between the positive electrode and the negative electrode) of the battery reaches a fully-charged voltage V_{FULL}. However, the charging time in the constant-voltage mode is longer because a lowered charging current is used to charge the battery to a full voltage in order to regulate the battery voltage within a safe voltage range.

In FIG. 1, curve I represents the voltage profile of a general charging circuit and curve II represents the sum of the charging voltage and the voltage across internal resistor (ΔV_{BIR}) of the battery. Therefore, during the charging process, after the external terminal voltage V_{BATO} of the battery reaches the fully-charged voltage V_{FULL}, the battery voltage continues to increase to a pre-determined value and then drops to the fully-charged voltage V_{FULL}. However, in the industry, the estimation of the voltage across battery internal resistor ΔV_{BIR} is based on empiricism. This may result in battery damage when batteries with identical specifications made by different manufacturers are charged based on the method disclosed in FIG. 1.

Therefore, there is a need in providing a charging circuit that is adjustable according to actual parameters of a battery.

### SUMMARY

In view of the above, the present disclosure provides a battery charging circuit for charging a battery. The battery charging circuit includes a control module and a charging mode adjusting module. The charging mode adjusting module adjusts a charging mode according to a voltage value or a current value of the battery. The charging mode adjusting module includes a charging unit and a detecting unit. The charging unit provides a charging current or a charging voltage to charge the battery. The detecting unit is electrically connected to the charging unit to detect the voltage value or the current value of the battery. When an external terminal voltage of the battery is within a voltage range near a first pre-determined voltage, the control module calculates an internal capacitance of the battery according to the charging current and a voltage variation of the battery within a pre-determined time interval. When the voltage value of the battery reaches the first pre-determined voltage, an internal resistance of the battery is calculated according to a current variation of the charging current. A fast charging mode is provided to charge the battery according to the internal capacitance and the internal resistance of the battery.

The battery charging circuit further includes a storage module for storing a plurality of charging parameters of the fast charging mode.

The charging mode adjusting module further includes a timer unit for providing a clock signal.

When the voltage value of the battery is within the voltage range near the first pre-determined voltage, the battery charging circuit provides a pre-determined current to charge the battery.

The charging unit provides a pre-determined current to charge the battery when the battery charging circuit is in the fast charging mode, the pre-determined current is lowered when the external terminal voltage of the battery reaches a second pre-determined voltage, and the second pre-determined voltage is determined according to the internal resistance.

The present disclosure provides a battery charging method for charging a battery. The battery charging method includes the following steps. An internal capacitance of the battery is calculated when an external terminal voltage of the battery is within a voltage range near a first pre-determined voltage. An internal resistance of the battery is calculated according to a charging current variation when the external terminal voltage of the battery reaches the first pre-determined voltage. A fast charging mode is provided to charge the battery according to the internal capacitance and the internal resistance of the battery.

The first pre-determined voltage is a rated fully-charged voltage of the battery.

The internal capacitance is calculated according to a voltage variation within the voltage range and a time variation.

A pre-determined current is provided to charge the battery when the fast charging mode is provided to charge the battery. The pre-determined current is lowered when the external terminal voltage of the battery reaches a second pre-determined voltage. The second pre-determined voltage is determined according to the internal resistance.

As previously stated, the battery charging circuit according to the present disclosure is capable of detecting the internal resistance and the internal capacitance of a battery during various charging periods to acquire actual parameters of the battery so as to provide a fast charging mode to charge the battery with shortened charging time in the constant-voltage mode.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 shows the voltage profile of a general charging circuit;

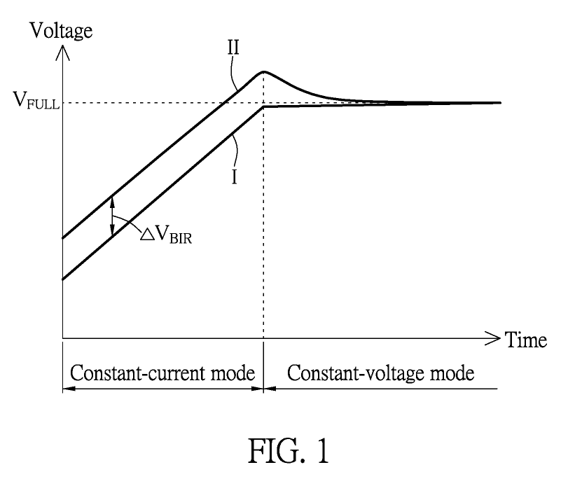

FIG. 2 shows a schematic diagram of a battery charging circuit according to one embodiment of the present disclosure;

FIG. 3 shows a simplified circuit diagram of a battery charging circuit according to one embodiment of the present disclosure;

FIG. 4 shows a charging voltage profile and a charging current profile according to one embodiment of the present disclosure;

FIG. 5 shows a charging voltage profile and a charging current profile during the charging process of a battery charging circuit according to one embodiment of the present disclosure; and

FIG. 6 shows a flowchart of a battery charging method according to one embodiment of the present disclosure.

### DESCRIPTION OF THE EXEMPLARY EMBODIMENTS

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure.

While such terms as “first,” “second,” “third,” etc., may be used to describe various components, such components must not be limited to the above terms. The above terms are used only to distinguish one component from another. For example, a second component may be referred to as a first component within the scope of the present disclosure, and similarly, the first component may be referred to as the second component. As used herein, the term “and/or” includes any and all combinations of one or more of the associated listed items.

The battery charging circuit will be exemplified by at least one embodiment with reference to the figures herein. However, the at least one embodiment is not intended to limit the scope of the present disclosure.

(Embodiment of Battery Charging Circuit)

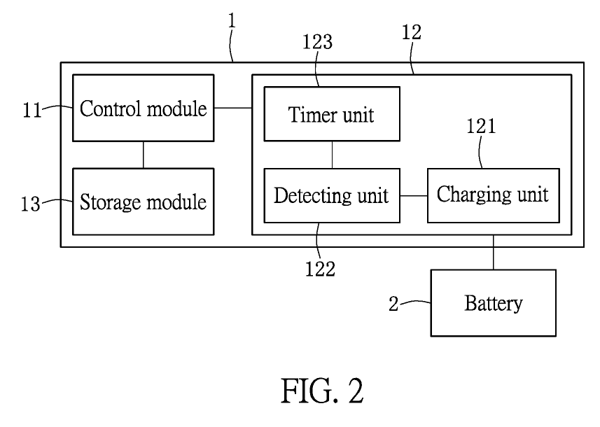

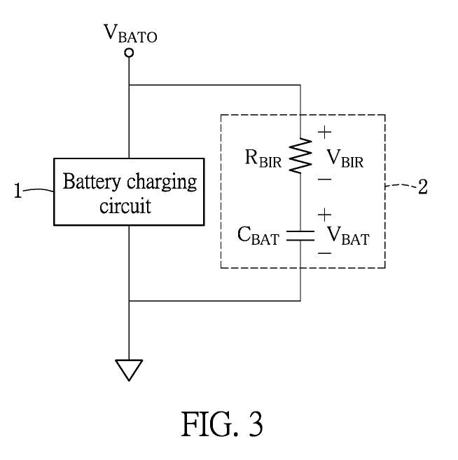

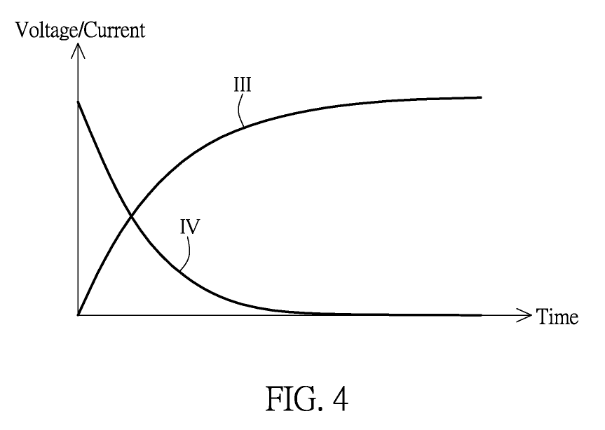

Referring to FIG. 2 to FIG. 4, FIG. 2 shows a schematic diagram of a battery charging circuit, FIG. 3 shows a simplified circuit diagram of a battery charging circuit, and FIG. 4 shows a charging voltage profile and a charging current profile according to one embodiment of the present disclosure.

The battery charging circuit 1 includes a control module 11, a charging mode adjusting module 12 and a storage module 13. The charging mode adjusting module 12 includes a charging unit 121, a detecting unit 122 and a timer unit 123.

The battery charging circuit 1 is electrically connected to a battery 2 to charge the battery 2 with a charging voltage and a charging current.

The control module 11 is electrically connected to the storage module 13 and the charging mode adjusting module 12.

In the present embodiment, the charging mode adjusting module 12 adjusts a charging mode according to a voltage value or a current value of the battery 2. The charging unit 121 provides the charging current or the charging voltage to charge the battery 2. The detecting unit 122 detects the voltage value or the current value of the battery 2. The timer unit 123 provides a clock signal and detects with the detecting unit 122 a voltage variation of the battery 2 in a time period or a current variation of the charging current of battery charging circuit 1 in a time period. In the present embodiment, the timer unit 123 provides the clock signal in picoseconds.

Referring to FIG. 3, FIG. 3 shows a simplified charging circuit and an equivalent circuit of the battery 2. The equivalent circuit of the battery 2 includes a battery internal resistor R_{BIR} and a battery internal capacitor C_{BAT}. In other words, the battery 2 can be simplified by a resistor R_{BIR} and a large capacitor C_{BAT} connected in series. The voltage across the battery internal resistor R_{BIR} and the battery internal capacitor C_{BAT} is the voltage across battery internal resistor (V_{BIR}) and the voltage across battery internal capacitor (V_{BAT}) of the battery 2, respectively. In other words, the battery external terminal voltage V_{BATO} viewed from the external terminal of the battery 2 equals the sum of the voltage across battery internal resistor (V_{BIR}) and the voltage across battery internal capacitor (V_{BAT}). Actually, the electricity stored in the battery 2 is the electricity charged with the voltage across battery internal capacitor (V_{BAT}), and the voltage across battery internal resistor (V_{BIR}) indicates the wasted power consumption in the battery 2. In other words, the battery 2 is completely charged when the voltage across battery internal capacitor (V_{BAT}) reaches a fully-charged voltage V_{FULL}.

Referring to FIG. 4, curve III and curve IV represent the variations of the voltage across battery internal capacitor and the charging current in the constant-voltage mode during the charging process, respectively, which can be expressed as:

$$\begin{matrix}Vc = \frac{Q}{{C}_{BAT}} = E ( 1 - {e}^{- \frac{t}{{R}_{BIR} * {C}_{BAT}}} ) & ( 1 ) \\ Ic = \frac{E}{{R}_{BIR}} * {e}^{( - \frac{t}{{R}_{BIR} {C}_{BAT}} )} & ( 2 )\end{matrix}$$

In Equations (1) and (2), Vc represents the variation of the voltage across battery internal capacitor (V_{BAT}) of the battery 2 during the charging process in the constant-voltage mode, Ic represents the current variation of the battery 2 during the charging process in the constant-voltage mode. More particularly, E represents the charging voltage, R_{BIR} represents the internal resistance of the battery 2, C_{BAT} represents the internal capacitor of the battery 2. According to Equations (1) and (2), when the charging time gets longer, the voltage across battery internal capacitor (V_{BAT}) approaches more to the charging voltage E. The charging current gradually decreases to a value lower than a pre-determined value.

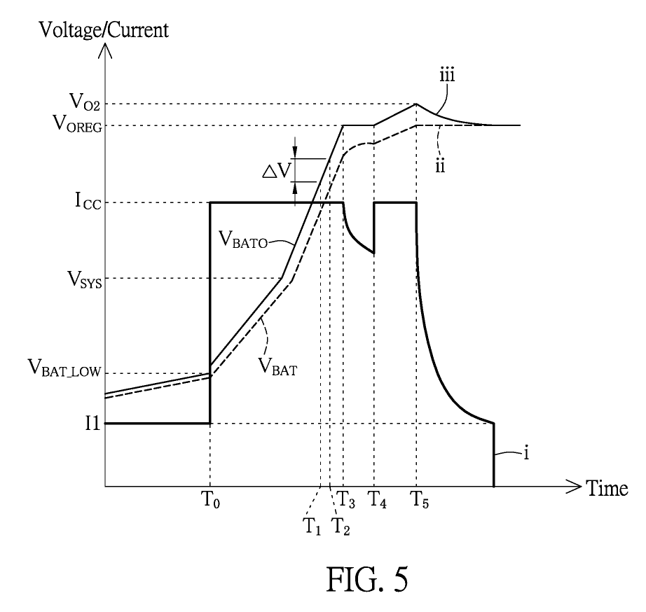

Referring to FIG. 5, FIG. 5 shows a charging voltage profile and a charging current profile during the charging process of a battery charging circuit according to one embodiment of the present disclosure.

In FIG. 5, curve i represents the current-time relation of the charging current, curve ii represents the voltage-time relation of the voltage across battery internal capacitor V_{BAT}, and curve iii represents the voltage-time relation of the battery external terminal voltage V_{BATO} of the battery 2.

First, referring to curve i in FIG. 5, at the beginning of the charging process, the battery charging circuit 1 charges the battery 2 with a lower current I1 until the pre-determined time T0 when the external terminal voltage V_{BATO} of the battery 2 is higher. In other words, when the external terminal voltage V_{BATO} of the battery 2 reaches a low battery voltage V_{BAT}_{_}_{LOW}, the battery charging circuit 1 charges the battery 2 with a larger current Icc. In the time period when the battery 2 is charged in the constant-current mode, the charging current continues to charge the battery 2 with the current value Icc. As the electric energy stored in the battery 2 increases, both the voltage across battery internal capacitor V_{BAT} represented by curve ii and the battery external terminal voltage V_{BATO} represented by curve iii increases. When the external terminal voltage V_{BATO} of the battery 2 increases to approach a pre-determined voltage range near a first pre-determined voltage V_{OREG}, the detecting unit 122 detects a voltage variation of the battery 2. In FIG. 5, the voltage variation ΔV of the battery external terminal voltage V_{BATO} between the first time T₁ and the second time T₂ is detected. In the present embodiment, the pre-determined voltage range is determined between the system voltage Vsys and the rated fully-charged voltage V_{OREG}. Moreover, in the present embodiment, the pre-determined voltage range is higher than 90% of the rated fully-charged voltage V_{OREG}. In other embodiments, the voltage range can be determined different from the present embodiment, to which the present disclosure is not limited.

Meanwhile, since the battery 2 is charged in the constant-current mode, the external terminal voltage V_{BATO} of the battery continues to increase. The internal capacitor C_{BAT} of the battery 2 can be calculated as below:

$${C}_{BAT} = Icc * \frac{( T 2 - T 1 )}{Δ V} \qquad ( 3 )$$

In the present embodiment, when the external terminal voltage V_{BATO} of the battery 2 reaches a rated fully-charged voltage V_{OREG}, the charging mode adjusting module 12 operates in the constant-voltage mode, and the charging unit 121 of the battery charging circuit 1 lowers the charging current. In the present embodiment, the charging current starts to drop from the current value Icc at the third time T₃. At the fourth time T₄, the charging current drops to 90% of the current value Icc. According to Equation 2, the time for the charging current Icc to change by 10% equals 0.1*(Rₘ*C_{BAT}). The control module 11 of the battery charging circuit 1 calculates the internal resistance R_{BIR} of the battery 2 according to the current variation (10% variation of the charging current Icc) between the third time T₃ and the fourth time T₄, which can be expressed as:

R_{BIR}=(T₄−T₃)/(0.1*C_{BAT}) (4)

In Equation 4, the time constant in the RC charging/discharging circuit equals the resistance multiplied by the capacitance. In other words, when the charging current drops from 100% of the current value Icc to 90% of the current value Icc, the time is 0.1τ. Equation 4 will be exemplified by actual values herein.

First, if the time for the charging current to drop from 100% of the current value Icc to 90% of the current value Icc is 50 μs, and the capacitance of the battery 2 calculated by Equation (3) is 100 mF, the internal resistance of the battery 2 can be expressed as:

R_{BIR}=50 μs/(0.1*100 mF)=5 mΩ

After the internal resistance R_{BIR} of the battery 2 and the internal capacitance C_{BAT} of the battery 2 are calculated, the battery charging circuit 1 charges the battery 2 in a fast charging mode.

In the present embodiment, the fast charging mode for the battery 2 provides the charging current and suitable voltage detection points according to the internal resistance R_{BIR} and the internal capacitance C_{BAT} of the battery 2. In the present embodiment, the battery charging circuit 1 continues to provide the charging current Icc to charge the battery 2 until the external terminal voltage V_{BATO} of the battery 2 reaches a second pre-determined voltage V_{O1}. The charging current Icc drops after the battery external terminal voltage V_{BATO} reaches the second pre-determined voltage V_{O2}. The second pre-determined voltage V_{O2} is determined according to the battery internal resistance R_{BIR}. In the present embodiment, the second pre-determined voltage V_{O2} equals the sum of the rated fully-charged voltage V_{OREG} and the voltage across battery internal resistor V_{BIR}. V_{BIR} equals Icc*R_{BIR}.

That is, the voltage across battery internal resistor V_{BIR} equals the current value Icc multiplied by the battery internal resistance R_{BIR}. Therefore, the voltage across battery internal capacitor (V_{BAT}) equals the rated fully-charged voltage V_{OREG}, and the battery 2 is completely charged. In other words, as indicated by the voltage curve at the fifth time T₅ in FIG. 5, the charging current starts to drop at the fifth time T₅ until it reaches zero.

According to the charging process of the battery 2 by the battery charging circuit 1, the battery charging circuit 1 provides effective charging parameters to speed up the charging process based on the internal parameters of the battery 2. In the present embodiment, the internal parameters of the battery 2 include, for example, the battery internal resistance R_{BIR}, the battery internal capacitance C_{BAT}, etc., which can be stored in the storage module 13.

(Embodiment of Battery Charging Method)

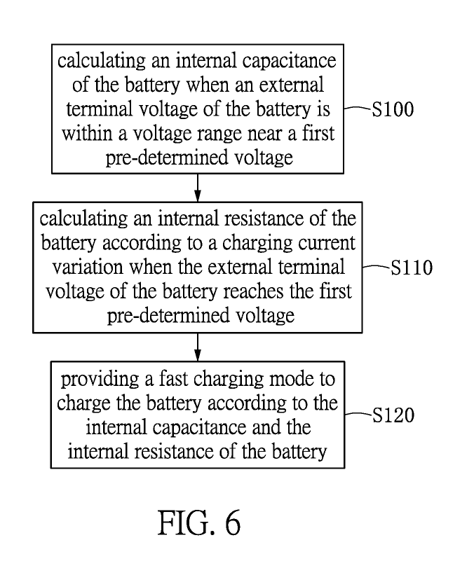

Referring to FIG. 6, FIG. 6 shows a flowchart of a battery charging method according to one embodiment of the present disclosure.

In the present embodiment, the battery charging method can be used with the previously disclosed battery charging circuit 1 and battery 2, and detailed descriptions thereof are not repeated.

The present disclosure provides a battery charging method for charging a battery 2. The battery charging method of the present embodiment includes the following steps. In Step S100, an internal capacitance of the battery is calculated when an external terminal voltage of the battery is within a voltage range near a first pre-determined voltage. In Step S110, an internal impedance of the battery is calculated according to a charging current variation when the external terminal voltage of the battery reaches the first pre-determined voltage. In Step S120, a fast charging mode is provided to charge the battery according to the internal capacitance and the internal impedance of the battery.

In Step S100, the battery charging circuit 1 charges the battery 2 in a constant-current mode. Meanwhile, the battery charging circuit 1 charges the battery 2 with a charging current Icc such that the external terminal voltage V_{BATO} of the battery 2 continues to increase. When the external terminal voltage V_{BATO} of the battery 2 increases to approach a pre-determined voltage range, the detecting unit 122 detects a voltage variation ΔV of the battery 2. In the present embodiment, the pre-determined voltage range is determined between the system voltage Vsys and the rated fully-charged voltage V_{OREG}. Moreover, in the present embodiment, the pre-determined voltage range is higher than 90% of the rated fully-charged voltage V_{OREG}. In other embodiments, the voltage range can be determined different from the present embodiment, to which the present disclosure is not limited. In the present embodiment, the system voltage Vsys is a system voltage enabling an electronic device to operate normally.

Moreover, the internal capacitance C_{BAT} of the battery 2 can be calculated according to Equation (3). In the present embodiment, the first pre-determined voltage is a rated fully-charged voltage V_{OREG}.

In Step S110, when the external terminal voltage V_{BATO} of the battery 2 reaches a first pre-determined voltage, i.e., the rated fully-charged voltage V_{OREG} in the present embodiment, the charging unit 121 of the battery charging circuit 1 starts to lower the charging current at the third time T₃ until the charging current drops to 90% of the current value Icc at the fourth time T₄. Then, the control module 11 of the battery charging circuit 1 can calculate the internal resistance R_{BIR} of the battery 2 according to the current variation (10% variation of the charging current Icc) between the third time T₃ and the fourth time T₄, which can be expressed as Equation (4).

In Step S120, after the internal resistance R_{BIR} of the battery 2 and the internal capacitance C_{BAT} of the battery 2 are calculated, the battery charging circuit 1 can provide the fast charging mode to charge the battery 2.

In the present embodiment, the fast charging mode for the battery 2 provides the charging current and suitable voltage detection points according to the internal resistance R_{BIR} and the internal capacitance C_{BAT} of the battery 2. In the present embodiment, the battery charging circuit 1 continues to provide the charging current Icc to charge the battery 2 until the external terminal voltage V_{BATO} of the battery 2 reaches a second pre-determined voltage V_{O2}. The battery external terminal voltage V_{BATO} drops after it reaches the second pre-determined voltage V_{O2}. The charging current Icc drops after the battery external terminal voltage V_{BATO} reaches the second pre-determined voltage V_{O2}. The second pre-determined voltage V_{O2} is determined according to the battery internal resistance R_{BIR}. In the present embodiment, the second pre-determined voltage V_{O2} equals the sum of the rated fully-charged voltage V_{OREG} and the voltage across battery internal resistor V_{BIR}. The voltage across battery internal resistor V_{BIR} equals Icc*R_{BIR}.

(Function of Embodiment)

As previously stated, the battery charging circuit according to the present disclosure is capable of detecting the internal resistance and the internal capacitance of a battery during various charging periods to acquire actual parameters of the battery so as to provide a fast charging mode to charge the battery with shortened charging time in the constant-voltage mode.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A battery charging circuit for charging a battery, the battery charging circuit comprising:
a control module; and
a charging mode adjusting module for adjusting a charging mode according to a voltage value or a current value of the battery, the charging mode adjusting module comprising:
a charging unit for providing a charging current or a charging voltage to charge the battery; and
a detecting unit electrically connected to the charging unit to detect the voltage value or the current value of the battery;
wherein, when a battery external terminal voltage of the battery is within a voltage range near a first pre-determined voltage, the control module calculates a battery internal capacitance of the battery according to the charging current and a voltage variation of the battery within a pre-determined time interval;
wherein, when the voltage value of the battery reaches the first pre-determined voltage, a battery internal resistance of the battery is calculated according to a current variation of the charging current;
wherein a fast charging mode is provided to charge the battery according to the battery internal capacitance and the battery internal resistance of the battery.

2. The battery charging circuit of claim 1, further comprising:
a storage module for storing a plurality of charging parameters of the fast charging mode.

3. The battery charging circuit of claim 1, wherein the charging mode adjusting module further comprises:
a timer unit for providing a clock signal.

4. The battery charging circuit of claim 1, wherein, when the voltage value of the battery is within the voltage range near the first pre-determined voltage, the battery charging circuit provides a pre-determined current to charge the battery.

5. The battery charging circuit of claim 1, wherein the charging unit provides a pre-determined current to charge the battery when the battery charging circuit is in the fast charging mode, the pre-determined current is lowered when the battery external terminal voltage of the battery reaches a second pre-determined voltage, and the second pre-determined voltage is determined according to the battery internal resistance.

6. A battery charging method for charging a battery, the battery charging method comprising:
calculating a battery capacitance of the battery when a battery external terminal voltage of the battery is within a voltage range near a first pre-determined voltage;
calculating a battery internal resistance of the battery according to a charging current variation when the battery external terminal voltage of the battery reaches the first pre-determined voltage; and
providing a fast charging mode to charge the battery according to the battery internal capacitance and the battery internal resistance of the battery.

7. The battery charging method of claim 6, wherein the first pre-determined voltage is a rated fully-charged voltage of the battery.

8. The battery charging method of claim 6, wherein the battery internal capacitance is calculated according to a voltage variation within the voltage range and a time variation.

9. The battery charging method of claim 6, wherein a pre-determined current is provided to charge the battery when the fast charging mode is provided to charge the battery, the pre-determined current is lowered when the battery external terminal voltage of the battery reaches a second pre-determined voltage, and the second pre-determined voltage is determined according to the battery internal resistance.
